(19) United States
(12) Patent Application Publication
(10) Pub. No.: US 2022/0147823 A1
(43) Pub. Date: May 12, 2022

(54) METHOD AND APPARATUS FOR ANALYZING TEXT DATA CAPABLE OF ADJUSTING ORDER OF INTENTION INFERENCE

(71) Applicant: MISOINFO Tech., Seoul (KR)

(72) Inventors: Sangdo Nam, Seoul (KR); Dong Uk An, Seoul (KR); Dong Woo Kim, Incheon (KR); Jin Ho Son, Gyeonggi-do (KR)

(21) Appl. No.: 17/522,048

(22) Filed: Nov. 9, 2021

(30) Foreign Application Priority Data
Nov. 9, 2020 (KR) 10-2020-0148815

(51) Int. Cl. G06N 3/08; G06F 16/33

(52) U.S. Cl. CPC G06N 3/08; G06F 16/3344

(57) ABSTRACT

Disclosed is a method for analyzing text data, which is performed by a computing device including at least one processor. The method may include: acquiring a query text; determining a priority among a plurality of analysis modules for analyzing the query text based on priority determination information input from a user; and analyzing the query text through at least one analysis module of the plurality of analysis modules based on the determined priority.

### CROSS-REFERENCE TO RELATED APPLICATIONS

This application claims priority to and the benefit of Korean Patent Application No. 10-2020-0148815 filed in the Korean Intellectual Property Office on Nov. 9, 2020, the entire contents of which are incorporated herein by reference.

### TECHNICAL FIELD

The present disclosure relates to a text data analyzing method, and more particularly, to a method for analyzing text data by adjusting an order for a plurality of analysis methods.

### BACKGROUND ART

In a natural language processing field, as a text analyzing method, there are various methods. Further, in recent years, with the development of technology related to an artificial neural network, a text analyzing method based on an artificial neural network model has also been spotlighted.

Since a rule based text analyzing method is based on a scheme of comparing prestored data and new input data, when the number of prestored data increases, an average analysis speed increases in linear proportion to the number of prestored data. Further, there is a problem in that except for the prestored data, other data is vulnerable to a new type of input.

The artificial neural network model based text analyzing method has a disadvantage in that it is impossible to use the artificial neural network model based text analyzing method when the number of initial data is small in that it is possible to create a model which can be used only when the number of secured data is large and learning is smoothly performed. Further, since all models should be driven irrespective of a difficulty of input data, there is a disadvantage in that computing resources are excessively used even with respect to a problem which can be simply handled.

As a result, in the art, a demand for a text analysis method in which the rule based analysis method and the artificial neural network based analysis method are appropriately combined has been continuously present.

Korean Patent Application No. “KR10-2019-0035436” discloses Method, Server and Computer Program for Managing Natural Language Processing Engines.

### SUMMARY OF THE INVENTION

The present disclosure is contrived to correspond to the above-described background art, and provides a method capable of adjusting an analysis order in analyzing text data.

An exemplary embodiment of the present disclosure provides a method for analyzing text data, which is performed by a computing device including at least one processor. The method may include: acquiring a query text; determining a priority among a plurality of analysis modules for analyzing the query text based on priority determination information input from a user; and analyzing the query text through at least one analysis module of the plurality of analysis modules based on the determined priority.

In an alternative exemplary embodiment, the plurality of analysis modules may include at least two of a pattern matching module, a morpheme analysis module, a language rule based analysis module, or a deep learning based analysis module.

In an alternative exemplary embodiment, the pattern matching module may analyze the query text based on one or more pattern matching degrees calculated by matching a pattern of the query text and each of patterns of one or more existing texts prestored.

In an alternative exemplary embodiment, the analyzing of the query text through the morpheme analysis module may include acquiring a morpheme analysis result for the query text through the morpheme analysis module, and analyzing the query text based on a morpheme analysis result for the query text and a morpheme analysis result for at least one existing text.

In an alternative exemplary embodiment, the analyzing of the query text based on the morpheme analysis result for the query text and the morpheme analysis result for at least one existing text may include calculating a first similarity between the morpheme analysis result for the query text and the morpheme analysis result for at least one existing text, calculating one or more candidate texts from the at least one existing text based on the first similarity, and analyzing the query text based on a second similarity calculated between the query text and the one or more candidate texts.

In an alternative exemplary embodiment, the first similarity may be calculated based on one or more term frequencies commonly included in the morpheme analysis result for the query text and the morpheme analysis result for the at least one existing text, and the second similarity may be calculated based on a common character between the query text and the one or more candidate texts.

In an alternative exemplary embodiment, the language rule based analysis module may analyze the query text based on a language rule set including at least one language rule.

In an alternative exemplary embodiment, the language rule may be generated based on association information calculated for one or more existing texts based on concept information.

In an alternative exemplary embodiment, the priority determination information may include order information for determining an application order of the plurality of analysis modules for the query text, or a threshold for at least one analysis accuracy of analysis accuracies for the plurality of respective analysis modules.

In an alternative exemplary embodiment, the method for analyzing a text may further include providing a user interface for receiving the priority determination information from a user.

In an alternative exemplary embodiment, the user interface may include at least one of an icon for each of a plurality of analysis modules of which the priority is determined according to a position on a display screen, the analysis accuracy for each of the plurality of analysis modules, and a threshold input field for the analysis accuracy.

In an alternative exemplary embodiment, in the user interface, when the analysis accuracy of the deep learning based analysis module is less than a predetermined value, the icon for the pattern matching module may be positioned to have a higher priority than the icon for the deep learning based analysis module, and when the analysis accuracy of the deep learning based analysis module is equal to or more than the predetermined value, the icon for the deep learning based analysis module may be positioned to have a higher priority than the icon for the pattern matching module.

Another exemplary embodiment of the present disclosure provides non-transitory computer readable medium including a computer program. The computer program executes the following operations for analyzing text data when the computer program is executed by one or more processors, and the operations may include: acquiring a query text; determining a priority among a plurality of analysis modules for analyzing the query text based on priority determination information input from a user; and analyzing the query text through a plurality of analysis modules according to the determined priority.

Still another exemplary embodiment of the present disclosure provides an apparatus for analyzing text data. The apparatus may include: one or more processors; a memory; and a network, and the one or more processors may be configured to acquire a query text, determine a priority among a plurality of analysis modules for analyzing the query text based on priority determination information input from a user; and analyze the query text through the plurality of analysis modules according to the determined priority.

According to the present disclosure, a method for analyzing text data capable of adjusting an analysis order can be provided.

### BRIEF DESCRIPTION OF THE DRAWINGS

FIG. 1 is a block diagram of a computing device for analyzing text data according to an exemplary embodiment of the present disclosure.

FIG. 2 is a schematic view illustrating a network function according to an exemplary embodiment of the present disclosure.

FIG. 3 is a flowchart illustrating some of processes of analyzing a query text through a morpheme analysis module according to an exemplary embodiment of the present disclosure.

FIG. 4 is a flowchart illustrating a process for generating a language rule according to an exemplary embodiment of the present disclosure.

FIG. 5 is an exemplary diagram for a user interface including an icon for each of a plurality of analysis modules capable of adjusting an order.

FIG. 6 is a flowchart illustrating a process of a text analysis method according to an exemplary embodiment of the present disclosure.

FIG. 7 is a simple and normal schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

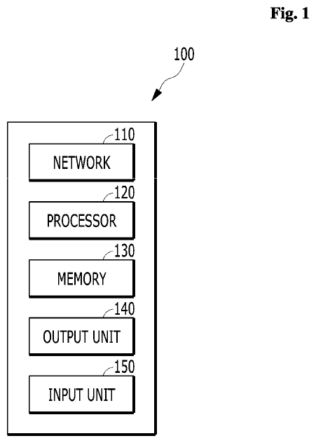

FIG. 1 is a block diagram of a computing device for analyzing text data according to an exemplary embodiment of the present disclosure. A computing device 100 for analyzing text data according to an exemplary embodiment of the present disclosure may include a network 110, a processor 120, a memory 130, an output unit 140, and an input unit 150.

According to an exemplary embodiment of the present disclosure, the network 110 may acquire a query text. The network 110 may also acquire the query text by transmitting and receiving to and from another computing device, another server, etc. In addition, the network 110 may enable communication among a plurality of computing devices so that operations for analyzing the text data according to the present disclosure is distributedly performed in each of the plurality of computing devices.

The network 110 according to an exemplary embodiment of the present disclosure may operate based on arbitrary type wired/wireless communication technology which is currently used and implemented, such as local area (short range), long range, wired, and wireless, and may be used even in other networks.

The processor 120 may be constituted by one or more cores and may include processors for learning a model, which include a central processing unit (CPU), a general purpose graphics processing unit (GPGPU), a tensor processing unit (TPU), and the like of the computing device. The processor 120 may determine a priority among a plurality of analysis modules for analyzing the query text. The processor 120 may determine a priority among a plurality of analysis modules for analyzing the query text based on priority determination information input from a user. The processor 120 may analyze the query text through at least one analysis module of the plurality of analysis modules based on the determined priority. Further, the processor 120 may determine to provide a user interface for receiving the priority determination information from the user. The user interface may be displayed to the user through the output unit 140.

According to an exemplary embodiment of the present disclosure, the memory 130 may store any type of information generated or determined by the processor 120 or any type of information received by the network 110. The memory 130 may store a computer program for analyzing text data according to an exemplary embodiment of the present disclosure and the stored computer program may also be executed by the processor 120.

A database according to an exemplary embodiment of the present disclosure may be the memory 130 included in the computing device 100. Alternatively, the database may be a memory included in a separate server or computing device linked with the computing device 100.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

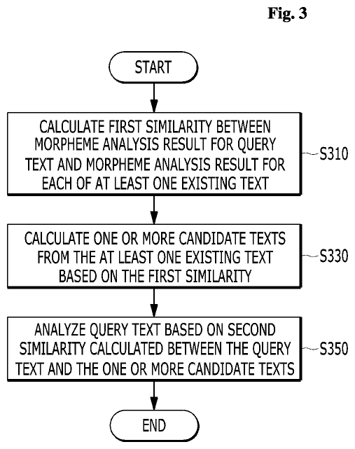

The output unit 140 according to an exemplary embodiment of the present disclosure may display a user interface (UI) for receiving the priority determination information for the plurality of analysis modules from the user. The output unit 140 may display the user interface illustrated in FIG. 3, for example. The user interfaces illustrated in the figures and described above are just examples and the present disclosure is not limited thereto.

The output unit 140 according to an exemplary embodiment of the present disclosure may output any type of information generated or determined by the processor 120 or any type of information received by the network 110.

The output unit 140 according to an exemplary embodiment of the present disclosure may include at least one of a liquid crystal display (LCD), a thin film transistor-liquid crystal display (TFT LCD), an organic light-emitting diode (OLED), a flexible display, and a 3D display. Some display modules among them may be configured as a transparent or light transmissive type to view the outside through the displays. This may be called a transparent display module and a representative example of the transparent display module includes a transparent OLED (TOLED), and the like.

User input may be received through the input unit 150 according to an exemplary embodiment of the present disclosure. The input unit 150 according to an exemplary embodiment of the present disclosure may include keys and/or buttons on the user interface or physical keys and/or buttons for receiving the user input. A computer program for controlling a display according to exemplary embodiments of the present disclosure may be executed according to the user input through the input unit 150.

The input unit 150 according to exemplary embodiments of the present disclosure receives a signal by sensing a button operation or a touch input of the user or receives speech or a motion of the user through a camera or a microphone to convert the received signal, speech, or motion into an input signal. To this end, speech recognition technologies or motion recognition technologies may be used.

The input unit 150 according to exemplary embodiments of the present disclosure may be implemented as external input equipment connected to the computing device 100. For example, the input equipment may be at least one of a touch pad, a touch pen, a keyboard, or a mouse for receiving the user input, but this is just an example and the present disclosure is not limited thereto.

The input unit 150 according to an exemplary embodiment of the present disclosure may recognize user touch input. The input unit 150 according to an exemplary embodiment of the present disclosure may be the same component as the output unit 140. The input unit 150 may be configured as a touch screen implemented to receive selection input of the user. The touch screen may adopt any one scheme of a contact type capacitive scheme, an infrared light detection scheme, a surface ultrasonic wave (SAW) scheme, a piezoelectric scheme, and a resistance film scheme. A detailed description of the touch screen is just an example according to an exemplary embodiment of the present disclosure and various touch screen panels may be adopted in the computing device 100. The input unit 150 configured as the touch screen may include a touch sensor. The touch sensor may be configured to convert a change in pressure applied to a specific portion of the input unit 150 or capacitance generated at the specific portion of the input unit 150 into an electrical input signal. The touch sensor may be configured to detect touch pressure as well as a touched position and area. When there is a touch input for the touch sensor, a signal(s) corresponding to the touch input is(are) sent to a touch controller. The touch controller processes the signal(s) and thereafter, transmits data corresponding thereto to the processor 120. As a result, the processor 120 may recognize which area of the input unit 150 is touched, and the like. According to the present disclosure, the computing device 100 may receive priority determination information from a user through the input unit 150.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

According to the present disclosure, the computing device 100 may analyze query texts acquired through a plurality of analysis modules. The plurality of analysis modules may include at least two of a pattern matching module, a morpheme analysis module, a language rule based analysis module, or a deep learning based analysis module. The computing device 100 according to the present disclosure takes a method for analyzing the query texts through the plurality of analysis modules, and as a result, the plurality of analysis modules may be used complementarily with each other, thereby enhancing a final analysis performance.

In the present disclosure, the analysis for the text may include a classification task for the text. The classification may include a classification for an intention of an input text. In the present disclosure, the text classification may include both a method using a classification result of an existing text acquired by a search result by searching a text having a high similarity to the query text based on a rule and a method for classifying the query text through at least one node by using an artificial neural network.

In an exemplary embodiment of the present disclosure, the pattern matching module may analyze the query text based on one or more pattern matching degrees calculated by matching the pattern of the query text and each of patterns of one or more existing texts prestored. The pattern of the text may be included in a character string included in the text. The pattern of the text may be a value considering all of character strings included in the text. For example, when there is a text such as “I ate an apple”, the pattern of the corresponding text may mean the character string itself. The pattern of the text may be acquired by performing a morpheme analysis for the text. For example, when the morpheme analysis is performed for the text such as “I ate an apple” and a stem is extracted, text patterns such as ‘I’, ‘apple’, and ‘ate’ may be acquired. A description for the text pattern is just an exemplary description and does not limit the present disclosure, and the present disclosure includes various patterns which may be generated based on the character string included in the text without a limit.

The computing device 100 according to an exemplary embodiment of the present disclosure may analyze the query text based on a pattern matching degree by matching the pattern of the query text and patterns of one or more existing texts with each other. As an exemplary embodiment, if the query text is “I want to eat pizza” and one existing text is “I want to eat chicken”, when it is assumed that the computing device 100 recognizes all character strings as the pattern of the text, it may be determined that in the query text and the existing text, 6 characters among 8 characters including a spacing character are matched. Alternatively, when it is assumed that the computing device 100 recognizes a morpheme analysis result as the pattern for the text, it may also be determined that there is a text pattern in which a query text having a morpheme analysis result of “food, eat, and want” and an existing text having a morpheme analysis result of “food, eat, and want” are completely matched. The computing device 100 may find an existing text having a highest pattern matching degree by comparing each of matching results of the pattern of the query text and the patterns of one or more existing texts. The computing device 100 may also perform an additional analysis based on the existing text having the highest pattern matching degree. When the patterns are completely matched, the pattern matching degree may represent 1 and when the patterns are not completely matched, the pattern matching degree may represent 0. An analysis accuracy calculated by the pattern matching module according to the present disclosure may be calculated based on the pattern matching degree. For example, the analysis accuracy of the pattern matching module may have an arbitrary of 0 or more or 1 or less.

According to an exemplary embodiment of the present disclosure, analyzing a query text through a morpheme analysis module may include: acquiring a morpheme analysis result for the query text through a morpheme analysis module, and analyzing the query text based on the morpheme analysis result for the query text and a morpheme analysis result for at least one existing text. The processor 120 may token a query text constituted by consecutive character strings in a predetermined unit as an operation for acquiring the morpheme analysis result. The predetermined unit may include, for example, a word phrase unit, a morpheme unit, a syllable unit, etc. The processor 120 may perform the morpheme analysis for a plurality of tokens after the tokening task for the query text. The morpheme analysis performed by the processor 120 may include, for example, a word class tagging operation, a stem extraction operation, a title word extraction operation, a stopword processing operation, etc. The stem extraction operation may include an operation of extracting only a part in which a form is not changed for meaning transfer in a linguistic use process for a token having a verb or adjective word class, i.e., a part preceding an end of word. The title word extraction operation may mean an operation of changing a word included in each token to a basic dictionary type word. The title word extraction operation may include, for example, an operation of changing a tense a verb expressed as a past type to a current tense which is a basic type verb. As another example, the title word extraction operation may also include an operation of changing a plurality of noun expressions to a single noun which is a basic type noun like an operation of changing “cats” to “cat”. The description of the morpheme analysis is just an example, and does not limit the present disclosure. The morpheme analysis result for the query text according to an exemplary embodiment of the present disclosure may include stem extraction information for the plurality of tokens included in the query text. Further, the morpheme analysis result may include title word extraction information for the plurality of tokens included in the query text.

FIG. 3 is a flowchart illustrating some of processes of analyzing a query text through a morpheme analysis module according to an exemplary embodiment of the present disclosure. According to an exemplary embodiment of the present disclosure, analyzing the query text by the computing device 100 may include calculating a first similarity between a morpheme analysis result for the query text and a morpheme analysis result for each of at least one existing text (S310), calculating one or more candidate texts from at least one existing text based on the first similarity (S330), and analyzing the query text based on a second similarity calculated between the query text and the one or more candidate texts (S350).

In step S310 of FIG. 3, the first similarity may be calculated based on one or more term frequencies commonly included in the morpheme analysis result for the query text and the morpheme analysis result for the at least one existing text. The one or more term frequencies included commonly may mean the number of commonly included tokens. For example, when tokens “A, B, C, and D” are present in the morpheme analysis result for the query text and tokens “A, C, E, and F” are present in a first existing text, the processor 120 may determine tokens “A and C” as tokens common to the query text and the first existing text. In a continued exemplary embodiment, when tokens “A, B, C, E, and F” are present in a second existing text, the processor 120 may determine tokens “A, B, and C” as tokens common to the query text and the second existing text. As a result, the processor 120 may assign a higher first similarity score to the second existing text than to the first existing text in the exemplary embodiment. In an exemplary embodiment, the first similarity score may also calculate the first similarity score the query text and each of one or more existing texts based on a TF-IDF algorithm.

In step S330 of FIG. 3, the processor 120 may calculate one or more candidate texts among one or more existing texts prestored based on the calculated first similarity. The processor 120 may calculate one or more candidate texts by comparing first similarity values calculated for respective existing texts. In an exemplary embodiment of the present disclosure, the processor 120 may calculate, as candidate texts, existing texts having higher M (M N) first similarity values according to an order of a first similarity having a larger value among N respective first similarities calculated between the query text and N existing texts. In another exemplary embodiment, the processor 120 may also calculate, as the candidate texts, one or more existing texts having a first similarity value of a threshold or more by comparing the first similarity values for one or more existing texts with a predetermined threshold.

In step S350 of FIG. 3, the processor 120 may analyze the query text based on a second similarity calculated between the query text and one or more candidate texts. The second similarity may be calculated based on a common character between the query text and one or more candidate texts. The computing device 100 according to the present disclosure may calculate one or more candidate texts based on the first similarity, and then calculate the second similarity by comparing the query text and character strings of one or more candidate texts. For an exemplary embodiment of the calculation of the second similarity, it is assumed that the query text has a character string “abcdefg”, a first candidate text has a character string “abcdxyz”, and a second candidate text has a character string “abcdefx”. In this case, the processor 120 may determine “abcd” as a common character string of the query text and the first candidate text. Further, the processor 120 may determine “abcdef” as a common character string of the query text and the second candidate text. The processor 120 may also compare a length of the common character string. As a result, the processor 120 may calculate the second similarity for each of one or more candidate texts by assigning a higher second similarity to a second candidate text having a length of the common character string as 6 than to a first candidate text having a length of the common character string as 4. The second similarity value may be assigned based on the length of the common character string. The second similarity value may also be a value calculated based on a jaro-winkler similarity algorithm. The description of the second similarity is just an exemplary description for the description, but the present disclosure includes various methods for calculating the similarity based on the common character between the query text and the candidate text without a limit.

The morpheme analysis module according to the present disclosure may calculate the analysis accuracy of the morpheme analysis module based on the second similarity. The morpheme analysis module may also calculate the analysis accuracy additionally based on the first similarity in addition to the second similarity. For example, the morpheme analysis module compares one or more existing texts and the query text to set a case where the existing text has the same length of the common character string as the query text to 1 and a case where there is no common character string to 0, but may calculate an arbitrary value between 0 and 1 as the analysis accuracy.

When the query text is analyzed through the morpheme analysis module according to the present disclosure, there is an advantage in that candidate texts may be primarily calculated based on the morpheme analysis result and secondarily, since a similar text is determined by comparing character strings, a total calculation amount of the computing device may be reduced and an existing similar text may be efficiently searched.

According to an exemplary embodiment of the present disclosure, the computing device 100 may analyze the query text based on the language rule based analysis module. The language rule based analysis module may analyze the query text based on a language rule set including at least one language rule. Hereinafter, a language rule generation method which becomes a basis when the language rule based analysis module analyzes the query text will be described.

The language rule according to the present disclosure may be generated based on association information calculated for one or more existing texts based on concept information. In the present disclosure, “concept information” may mean data including one or more concept sets.

In the present disclosure, “concept set” may mean a word set including one or more words. The “word” included in the concept set may also include arbitrary types of texts such as a phrase, a paragraph, a sentence, etc. One or more words included in the concept set may be similar words determined to be similar to each other based on predetermined characteristics. In an exemplary embodiment of the present disclosure, when there is one word included in the concept set, the corresponding word may determined to be similar only by one. The predetermined characteristics for determining whether the one or more words are similar may include, for example, a semantic similarity, a grammatical similarity, an ideological similarity, a perceptual similarity, etc. The semantic similarity may be, for example, characteristics of a plurality of words having the same or similar meaning, such as “act”, “code”, “law”, “rule”, etc. The grammatical similarity may be, for example, characteristics of a plurality of words which are grammatically modified with respect to the same word, such as “eat”, “ate”, “eat”, “ate”, etc. The ideological similarity may be, for example, characteristics of a plurality of words which frequently appear in actually using the language by transferring a similar feeling or idea to persons, such as “moon”, “rabbit”, etc. The perceptual similarity may be, for example, characteristics shared by a plurality of words which are recognized to be physically positioned in the same space, such as “monitor”, “mouse”, “keyboard”, etc. An example regarding the predetermined characteristics which become a basis of the similarity determination is just an example for the description, but does not limit the present disclosure, and in the present disclosure, the similarity between the plurality of words included in the concept set includes arbitrary characteristics without a limit. In the present disclosure, the “concept” may be used as a term for collecting calling the words included in the “concept set”. For example, “concept A” may be “collective calling of words included in concept set A”.

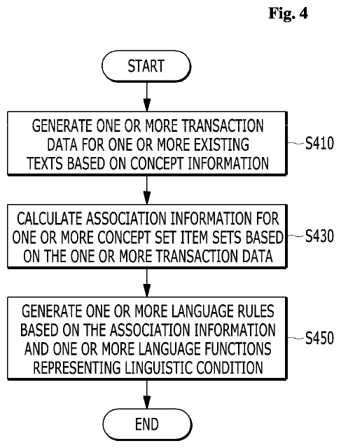

Hereinafter, referring to FIG. 4, a process of generating the language rule based on the association information calculated for one or more existing texts based on the concept information by the computing device 100 according to the present disclosure will be described. FIG. 4 is a flowchart illustrating a process for generating a language rule according to an exemplary embodiment of the present disclosure.

The computing device 100 according to the present disclosure may generate one or more transaction data for one or more existing texts based on the concept information (S410). The one or more existing texts may be text data pre-input and stored in the memory 130. The computing device 100 may check whether one or more concept sets included in the concept information are included in each existing text, and then generate the transaction data. The transaction data may include binary data indicating whether each of one or more concept sets is included for each text. The transaction data may be expressed in a matrix form. In the transaction data expressed in the matrix, each row may show the text and each column may show the concept set. In the transaction data expressed in the matrix, the binary data included in each cell may indicate whether each concept set is included in the corresponding text. The binary data may be expressed as True/False or I/O.

The computing device 100 according to the present disclosure may calculate association information for one or more concept set item sets based on the generated one or more transaction data (S430). The association information may be acquired according to an association analysis result.

The “concept set item set” according to an exemplary embodiment of the present disclosure means a set of one more concept sets. For example, when there is concept set A, concept set B, and concept set C, the concept set item set may be configured as A, B, C, (A,B), (B,C), (A,C), or (A,B,C). The concept set item set may also include only one concept set. The number of concept sets which may be included in the concept set item set may be an arbitrary natural number.

The association information according to the present disclosure may include a value for at least one scale of a support, a confidence, a lift, a leverage, and a conviction. The support may be expressed as in Equation 1.

$$support ( A \to B ) = \frac{n ( A ⋃ B )}{N} \qquad [ Equation 1 ]$$

n(A∪B )represents the number of text data simultaneously including concept sets expressed as A and B in A∪B. N represents the number of all text data. The support may express the number of text data including a word corresponding to a specific concept among one or more texts. When the support for one concept set is calculated, the support may be computed by Equation 2.

$$support ( A ) = \frac{n ( A )}{N} \qquad [ Equation 2 ]$$

n(A) represents the number of data including a word corresponding to concept A among all texts. That is, the support may be calculated even for one concept set.

The confidence according to an exemplary embodiment of the present disclosure may be expressed as in Equation 3.

$$confidence ( A \to B ) = \frac{support ( A \to B )}{support ( A )} \qquad [ Equation 3 ]$$

The confidence may be calculated based on the support according to Equations 1 and 2 above. Since the confidence means a ratio of data including even B among data including concept A, the confidence may include a meaning of a conditional probability. In the case of the confidence, when confidence(A→B) and confidence(B→A) are calculated, a size of a denominator may vary, and as a result, the confidence is an asymmetric scale. With respect to the confidence as one of the scales included in the association information, a feature according to the order of the word in the text may be considered.

The lift according to an exemplary embodiment of the present disclosure may be expressed as in Equation 4.

$$lift ( A \to B ) = \frac{confidence ( A \to B )}{support ( B )} \qquad [ Equation 4 ]$$

The lift may be calculated based on Equations 1 to 3 above. When the lift is 1, concepts A and B may be independent of each other. When the lift is larger than 1, concepts A and B may have a positive correlation with each other. When the lift is smaller than 1, concepts A and B may have a negative correlation with each other. Since it is guaranteed that values of lift(A→B) and lift(B→A) will be continuously equal to each other, the lift is a scale in which an exchange law is established.

The leverage according to an exemplary embodiment of the present disclosure may be expressed as in Equation 5.

life(A→B)=support(A→B)−support(A)×support(B) [Equation 5]

The conviction according to an exemplary embodiment of the present disclosure may be expressed as in Equation 6.

$$conviction ( A \to B ) = \frac{1 - support ( B )}{1 - confidence ( A \to B )} \qquad [ Equation 5 ]$$

The scales expressed by the above-described equations are just examples for one or more scales included in the association information, but the present disclosure may include various numerical data which may be generated from the transaction data without a limit.

The computing device 100 according to the present disclosure may calculate the association information, and then select only a concept set item set having a value equal to or more than a threshold for each scale. For example, the computing device 100 may select a concept set item set in which the calculated support value is 0.9 or more. Further, the computing device 100 may also select a concept set item set in which the support value is 0.9 or more and the value of the confidence is also 0.9 or more.

The computing device 100 according to the present disclosure may generate one or more language rule based on the association information and one or more language functions indicating a linguistic condition (S450).

The one or more language functions may include, for example, an AND function meaning an intersection of the concept, an OR function meaning a union of the concept, a distance function (DIST) between the concepts regardless of the order, a distance function (ORDDIST) between the concepts considering the order, a concept emergence frequency function (FREQ), a concept-start point distance function (START), or a concept-end point distance function (END).

The distance function (DIST) between the concepts regardless of the order may require a maximum value for the distance as a function parameter. The maximum value for the distance may be set based on a value input from the user, and also set to a default value. The default value may be, for example, 10. The distance function (DIST) between the concepts regardless of the order means a function to search a case where words corresponding two concepts commonly appear in one text, but is less than the maximum value for the distance. The distance function (ORDDIST) between the concepts considering the order is a function to search a case where a word corresponding to a preceding concept and a word corresponding to a trailing concept are distinguished, and the word is present according to the order, but the word is present to the set maximum distance value or less. The distance function between the concepts considering the order as the function parameter may also require the maximum value for the distance, and a description of the corresponding contents is duplicated with the distance function between the concepts regardless of the order, and as a result, the distance function is omitted.

The concept emergence frequency function (FREQ) may require a minimum frequency as a parameter. The concept emergence frequency function may represent the number of times at which one or more concepts are emerged in the text. For example, when the minimum frequency is set to 3, if the computing device 100 applies the concept emergence frequency function upon generating the language rule, it may be guaranteed that the generated language rule appears in one or more texts at least three times. The concept emergence frequency function may be used as one of the language functions in order to disregard a rule close to noise which excessively intermittently appears.

The concept-start point distance function (START) or the concept-end point distance function (END) is a language function to search a case where the concept is positioned at a maximum of N distance or less from the start point or end point of the text. The concept-start point distance function (START) or concept-end point distance function (END) as the function parameter may commonly require a maximum distance. For example, when the concept-start point distance function (START) has 5 as a maximum distance parameter, a text including an element word of the corresponding concept set may be detected within a fifth order from a first word phrase or word of the text. The concept-end point distance function (END) performs a similar function, but may be different from the concept-start point distance function (START) in that a reference point is a last word. The concept-start point distance function (START) or concept-end point distance function (END) may be a language function in which important information in the text generally includes a linguistic background knowledge which appears around the start point of the text or around the end point of the text.

The description of the type of language function included in one or more language functions is just an exemplary enumeration and does not limit the present disclosure. According to the present disclosure, one or more language functions indicating the linguistic condition is applied to generate a language rule for finding text data which meets the corresponding condition. For example, when ORDDIST is selected as the language function for the concept set item set including concepts A and B, the language rule may be expressed as (ORDDIST, 9, concept A, concept B). 9 included in the language rule may mean a distance between words corresponding to the concept. The selection of the language function may be performed based on a separate user input. The language function may also be determined as a predetermined type and a predetermined parameter value by the computing device 100.

The computing device 100 according to the present disclosure may generate the language rule according to steps S410, S430, S450, etc., of FIG. 4 as described above. The language rule based analysis module according to the present disclosure may analyze the query text based on a language rule set including at least one generated language rule. For example, the language rule set is generated to include two language rules such as “(OR, (ORDDIST, 9, concept A, concept B), (AND, concept C, concept D))” In this case, the computing device 100 may determine whether both a condition in which a word corresponding to concept B is to be discovered at a 9^{th} word after a word corresponding to concept A and a condition in which a word corresponding to concept C and a word corresponding to concept D are to be simultaneously present are satisfied through the language rule based analysis module for the query text. When all of one or more language rules included in the language rule set are satisfied, the corresponding query text may be classified into a text satisfying the language rule set. When there are N language rule sets according to the text type, the computing device 100 may classify the text into N types through the language rule based analysis module. Further, the language rule based analysis module according to the present disclosure may classify the query text as a classification result represented by the corresponding language rule set when language rules of a predetermined number or more among N language rules included in the language rule set are satisfied. The computing device 100 may apply all language rules included in the language rule set for the query text, and then calculate a ratio of the number of satisfied language rules to the total number with analysis accuracy. For example, when there are 100 language rules in a first language rule set and there are 20 language rules satisfied by the query text, the computing device 100 may calculate 20 as the analysis accuracy of the language rule based analysis module. When there are a plurality of language rule sets in the language rule based analysis module, the computing device 100 may calculate a largest value among the analysis accuracy calculated for each language rule set as the analysis accuracy for the language rule based analysis module.

As described above, the computing device 100 according to the present disclosure analyzes the query text through the pattern matching module, the morpheme analysis module, or the language rule based analysis module to determine a text which is most similar to the query text among one or more prestored existing texts and analyze the query text based thereon. For example, if the existing texts are between conversion histories between two or more speakers, the computing device 100 may analyze the text by a method for calculating a next text in which a text most similar to the query text is determined in the conversion history. Further, if the existing texts are classified based on a predetermined classification criterion, the computing device 100 may also classify a newly input query text by determining the existing text most similar to the query text.

According to an exemplary embodiment of the present disclosure, the computing device 100 may analyze the query text based on a deep learning based analysis module. The deep learning based analysis module may include a network function including at least one node.

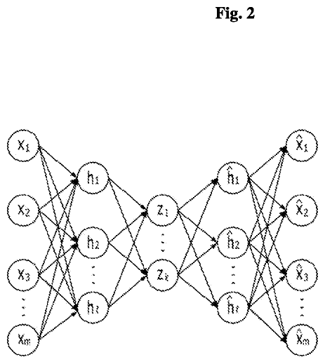

FIG. 2 is a schematic view illustrating a network function according to an exemplary embodiment of the present disclosure. An operation of analyzing the query text by the deep learning based analysis module according to the present disclosure may be performed based on the network function.

Throughout the present specification, a model, a computation model, the neural network, a network function, and the neural network may be interchangeably used as the same meaning. The neural network may be generally constituted by an aggregate of calculation units which are mutually connected to each other, which may be called nodes. The nodes may also be called neurons. The neural network is configured to include at least one node. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another exemplary embodiment of the present disclosure, the number of nodes of the input layer may be larger than the number of nodes of the output layer, and the neural network may be a neural network of a type in which the number of nodes increases from the input layer to the hidden layer. The neural network according to yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

In an exemplary embodiment of the present disclosure, the deep learning based analysis module may include a network function including at least one node. The deep learning based analysis module may perform a classification for a query text based on the network function. The classification may be a binary classification or a multi-dimensional classification. In an exemplary embodiment of the present disclosure, the computing device 100 may train the deep learning based analysis module in order to enhance analysis accuracy of the query text through the deep learning based analysis module. The training may be performed based on training data labeled with one or more correct answer classification labels. For example, the deep learning based analysis module may calculate a probability value for one or more classification labels thorough a computation, and in this case, the processor 120 may update one or more weights and deflection values included in the deep learning based analysis module so that the deep learning based analysis module calculates a probability value for a correct answer label close to 1 and calculates probability values for the remaining labels close to 0. The deep learning based analysis module according to the present disclosure may calculate the analysis accuracy based on a confidence score value for the corresponding label when predicting the correct answer label during a classification process for the query text.

The computing device 100 according to the present disclosure may provide a text analysis method that aggregates each advantage by using various types of analysis modules in order to analyze the text.

Priority determination information according to the present disclosure may include order information for determining an application order of a plurality of analysis modules to the query text or a threshold for at least one analysis accuracy among the analysis accuracy for each of the plurality of analysis modules. The computing device 100 may acquire the priority determination information from the user through a user interface. The computing device 100 may also determine the priority determination information according to pre-input information.

The computing device 100 according to the present disclosure may determine the application order of the plurality of analysis modules for the query text according to the order information included in the priority determination information. As an example, the computing device 100 may analyze the text by first applying the pattern matching module and second applying the deep learning based analysis module to the query text acquired according to the order information. As another example, the computing device 100 may also apply the pattern matching module first, the morpheme analysis module second, the language rule based analysis module third, and the deep learning based analysis module fourth to the query text. An example for the order information is just an example, and the present disclosure includes all orders available between two or more analysis modules. In the text analysis method according to the present disclosure, the order information included in the priority determination information may be arbitrarily changed. According to the present disclosure, an optimal analysis module application order may be determined by considering a performance or an analysis speed of each analysis module.

In an exemplary embodiment, a threshold for the analysis accuracy of each analysis module included in the priority determination information may become a reference value for changing an analysis module from a first module to a second module according to the order information. For example, when the pattern matching module has a first priority and the morpheme analysis module has a second priority, and the threshold for the analysis accuracy of the pattern matching module is 80, the computing device 100 may first analyze the query text acquired through the pattern matching module. When the analysis accuracy calculated by the pattern matching module is 70, the analysis accuracy of the pattern matching module is smaller than 80 which is the threshold, and as a result, the computing device 100 may analyze the query text through the morpheme analysis module having the second priority according to the order information. As described above, the analysis accuracy threshold for each of the plurality of analysis modules according to the present disclosure may become a criterion for the computing device 100 to determine whether to continuously perform the analysis for the query text through a next priority analysis module according to an order among the plurality of analysis modules. When the analysis module having the first priority calculates a higher analysis accuracy value than the threshold, the computing device 100 according to the present disclosure may terminate the analysis for the query text without performing an additional analysis by another module. Further, even though the higher-priority analysis module calculates a higher analysis accuracy value than the threshold, the computing device 100 according to the present disclosure may also perform the additional analysis by another module for subsequent additional training or evaluation of another module.

The computing device 100 according to an exemplary embodiment of the present disclosure may differently determine the analysis accuracy thresholds for the plurality of respective analysis modules. Accordingly, the computing device 100 may differently set a threshold appropriate to each analysis module by considering the completeness or training progress degree of each analysis module.

The computing device 100 according to the present disclosure may provide the user interface for receiving the priority determination information from the user through the output unit 140. The user interface may include at least one of an icon for each of a plurality of analysis modules of which the priority is determined according to a position on a display screen, the analysis accuracy for each of the plurality of analysis modules, or a threshold input field for the analysis accuracy.

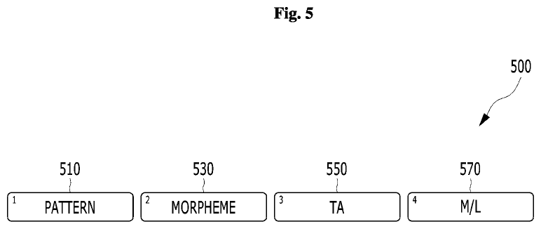

FIG. 5 is an exemplary diagram for a user interface including an icon for each of a plurality of analysis modules capable of adjusting an order. The exemplary user interface 500 may include at least one icon of an icon 510 representing the pattern matching module, the icon 530 representing the morpheme analysis module, an icon 550 representing the language rule based analysis module, or an icon 570 representing the deep learning based analysis module. For one or more icons included in the user interface, the priority for the application may be determined according to the position on the display screen. For example, as the icon is positioned at a further left side of the display screen, the icon has a higher priority, and as a result, the icon may be set as an analysis module which is earlier applied. When an interpretation is made based thereon, the computing device 100 may determine to apply each analysis module to the query text in the order of the pattern matching module, the morpheme analysis module, the language rule based analysis module, and the deep learning based analysis module according to the position of the icon in FIG. 5. As another example, although not illustrated, when icons representing one or more analysis modules are aligned in a vertical direction in the user interface, an analysis module of an icon which is present on an upper end than another icon in terms of the position on the screen may be determined to have a higher application priority to the query text than another analysis module. As yet another example, the priority may be directly input into the icon representing each analysis module. Each icon top-left number included in the exemplary user interface 500 may be a number representing a result acquired by directly inputting the application order. The examples of the method for determining the priority based on the position on the display are just examples, the user interface according to the present disclosure may include various exemplary embodiments capable of determining the priority according to each icon position based on a predetermined rule for a plurality of icons on the display screen without a limit.

The user interface according to the present disclosure may include analysis accuracy for each of the plurality of analysis modules or a threshold input field for the analysis accuracy. The analysis accuracy for each of the plurality of analysis modules may include an analysis accuracy value for a pre-input text and statistical data of the analysis accuracy value for the pre-input text. The user may determine current states of the plurality of analysis modules based on the analysis accuracy for each of the plurality of analysis modules included in the user interface and set the priority among the plurality of analysis modules based thereon. The computing device 100 may also make the analysis accuracy threshold input field for each of the plurality of analysis modules included in the user interface. For example, the analysis accuracy threshold input field may be a bar type capable of selecting an arbitrary point between a minimum value and a maximum value of the analysis accuracy. As another example, the analysis accuracy threshold input field may also be a text box into which an accurate value may be input. According to the present disclosure, the user may check the analysis accuracy of the analysis module through the threshold input field for the analysis accuracy included in the user interface, and then adjust the threshold according to a situation. Accordingly, according to the present disclosure, the computing device 100 may provide a flexible text analysis method suitable for the situation.

According to an exemplary embodiment of the present disclosure, in the user interface provided by the computing device 100, when the analysis accuracy of the deep learning based analysis module is less than a predetermined value, the icon for the pattern matching module may be positioned to have a higher priority than the icon for the deep learning based analysis module and when the analysis accuracy of the deep learning based analysis module is equal to or more than the predetermined value, the icon for the deep learning based analysis module may be positioned to have a higher priority than the icon for the pattern matching module. The predetermined value may be a value which becomes a criterion whether the analysis accuracy of the deep learning based analysis module has a significant level of accuracy. The predetermined value may have a value such as 0.95, etc., for example. The deep learning based analysis module is characterized to have higher accuracy as the training is in progress. In this case, adjusting the order of the analysis module by continuously checking the analysis accuracy by the user may cause big cost. Accordingly, the user interface according to the present disclosure includes the icons for the plurality of analysis modules, but differently displays the priority of the icon for the deep learning based analysis module according to whether the analysis accuracy of the deep learning based analysis module is equal to or more than a predetermined value to provide convenience of the user.

According to the present disclosure, there is an effect that user convenience for order adjustment among the plurality of analysis modules is increased through providing the user interface. Furthermore, according to the present disclosure, there is an advantage in that the order adjustment among the plurality of analysis modules is facilitated, while as a result, all analysis modules have enhanced analysis performance by combinationally using one or more analysis modules.

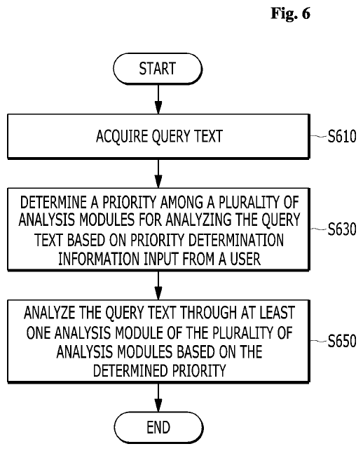

FIG. 6 is a flowchart illustrating a process of a text analysis method according to an exemplary embodiment of the present disclosure. In step S610, the computing device 100 may acquire a query text. The computing device 100 may acquire the query text through an input unit 150. The computing device 100 may also acquire the query text from another computing device through a network 110. In step S630, the computing device 100 may determine a priority among a plurality of analysis modules for analyzing the query text based on priority determination information input from a user. The computing device 100 may also provide a user interface for receiving the priority determination information from the user. The user interface may include icons representing the plurality of analysis modules, and modifies a position for the icon to determine the priority according to a relative position among the icons representing the plurality of analysis modules. The priority determination information may include order information among the plurality of analysis modules or a threshold for at least one analysis accuracy of analysis accuracies for the plurality of respective analysis modules. The threshold for the analysis accuracy may be a criterion value for determining whether to apply a second analysis module after applying a first analysis module for the query text when there are the first analysis module and the second analysis module according to the order. In step S650 of FIG. 6, the computing device 100 may analyze the query text through at least one analysis module of the plurality of analysis modules based on the determined priority.

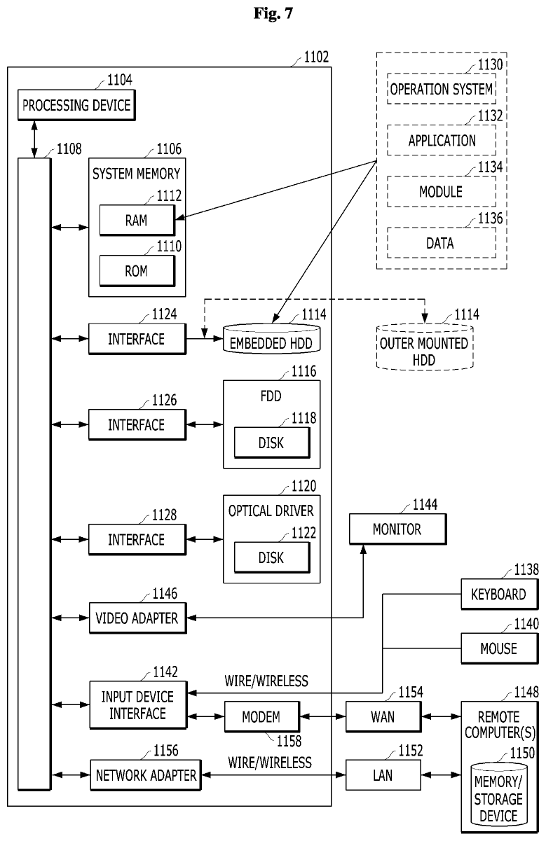

FIG. 7 is a simple and normal schematic view of an exemplary computing environment in which the exemplary embodiments of the present disclosure may be implemented. It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104. The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be interpreted within the widest range which is coherent with the principles and new features presented herein.

What is claimed is:

1. A method for analyzing text data, which is performed by a computing device including at least one processor, the method comprising:
acquiring a query text;
determining a priority among a plurality of analysis modules for analyzing the query text based on priority determination information input from a user; and
analyzing the query text through at least one analysis module of the plurality of analysis modules based on the determined priority.

2. The method of claim 1, wherein the plurality of analysis modules include at least two of a pattern matching module, a morpheme analysis module, a language rule based analysis module, or a deep learning based analysis module.

3. The method of claim 2, wherein the pattern matching module analyzes the query text based on one or more pattern matching degrees calculated by matching a pattern of the query text and each of patterns of one or more existing texts prestored.

4. The method of claim 2, wherein the analyzing of the query text through the morpheme analysis module includes
acquiring a morpheme analysis result for the query text through the morpheme analysis module, and
analyzing the query text based on the morpheme analysis result for the query text and a morpheme analysis result for at least one existing text.

5. The method of claim 4, wherein the analyzing of the query text based on the morpheme analysis result for the query text and the morpheme analysis result for at least one existing text includes
calculating a first similarity between the morpheme analysis result for the query text and the morpheme analysis result for at least one existing text,
calculating one or more candidate texts from the at least one existing text based on the first similarity, and
analyzing the query text based on a second similarity calculated between the query text and the one or more candidate texts.

6. The method of claim 5, wherein the first similarity is calculated based on one or more term frequencies commonly included in the morpheme analysis result for the query text and the morpheme analysis result for the at least one existing text, and
the second similarity is calculated based on a common character between the query text and the one or more candidate texts.

7. The method of claim 2, wherein the language rule based analysis module analyzes the query text based on a language rule set including at least one language rule.

8. The method of claim 7, wherein the language rule is generated based on association information calculated for one or more existing texts based on concept information.

9. The method of claim 1, wherein the priority determination information includes
order information for determining an application order of the plurality of analysis modules for the query text, or
a threshold for at least one analysis accuracy of analysis accuracies for the plurality of respective analysis modules.

10. The method of claim 1, further comprising:
providing a user interface for receiving the priority determination information from a user.

11. The method of claim 10, wherein the user interface includes at least one of an icon for each of the plurality of analysis modules of which the priority is determined according to a position on a display screen, the analysis accuracy for each of the plurality of analysis modules, and a threshold input field for the analysis accuracy.

12. The method of claim 11, wherein in the user interface,
when the analysis accuracy of a deep learning based analysis module is less than a predetermined value,
the icon for the pattern matching module is positioned to have a higher priority than the icon for the deep learning based analysis module, and
when the analysis accuracy of the deep learning based analysis module is equal to or higher than the predetermined value,
the icon for the deep learning based analysis module is positioned to have a higher priority than the icon for the pattern matching module.

13. A non-transitory computer readable medium including a computer program, wherein the computer program executes the following operations for analyzing text data when the computer program is executed by one or more processors, the operations comprising:
acquiring a query text;
determining a priority among a plurality of analysis modules for analyzing the query text based on priority determination information input from a user; and
analyzing the query text through a plurality of analysis modules according to the determined priority.

14. An apparatus for analyzing text data, the apparatus comprising:
one or more processors;
a memory; and
a network,
wherein the one or more processors are configured to:
acquire a query text,
determine a priority among a plurality of analysis modules for analyzing the query text based on priority determination information input from a user; and
analyze the query text through the plurality of analysis modules according to the determined priority.
